(19) United States
(12) Patent Application Publication
(10) Pub. No.: US 2026/0128556 A1
(43) Pub. Date: May 7, 2026

(54) CONNECTOR DEVICE

(71) Applicant: TOYOTA JIDOSHA KABUSHIKI KAISHA, Toyota-shi (JP)

(72) Inventors: Takumi YAMADA, Toyota-shi, (JP); Masaru SASAKI, Toyota-shi (JP); Hiroshi UKEGAWA, Toyota-shi (JP)

(73) Assignee: TOYOTA JIDOSHA KABUSHIKI KAISHA, Toyota-shi (JP)

(21) Appl. No.: 19/350,356

(22) Filed: Oct. 6, 2025

(30) Foreign Application Priority Data
Nov. 7, 2024 (JP) 2024-195079

(51) Int. Cl. H01R 13/66; B60L 53/16; H01R 13/631

(52) U.S. Cl. CPC H01R 13/6691; B60L 53/16; H01R 13/631; H01R 13/6616; H01R 2201/26

(57) ABSTRACT

The connector device includes a connector including a first end on which a fitting portion fitted to the inlet and a locking portion for locking the fitting portion are provided, an AC charging cable configured to be detachably attached to a second end of the connector and electrically connected to an external power supply, and an AC discharge connector configured to be detachably attached to the second end and electrically connected to an electrical device. The AC charging cable transmits power from the external power supply to the connector in a state where the AC charging cable is electrically connected to the external power supply and is connected to the second end. The AC discharge connector transmits the power from the connector to the electrical device in a state where the AC discharge connector is electrically connected to the electrical device and is connected to the second end.

### CROSS-REFERENCE TO RELATED APPLICATION

This application claims priority to Japanese Patent Application No. 2024-195079 filed on Nov. 7, 2024. The disclosure of the above-identified application, including the specification, drawings, and claims, is incorporated by reference herein in its entirety.

### BACKGROUND

### 1. Technical Field

The present disclosure relates to a connector device.

### 2. Description of Related Art

Japanese Unexamined Patent Application Publication No. 2013-211146 (JP 2013-211146 A) discloses a power supply connector that is attached to an inlet of a vehicle to enable power supply to an external load.

### SUMMARY

Although not described in JP 2013-211146 A, the power supply connector has a configuration different from a charging connector that is attached to an inlet when a power storage device of the vehicle is charged. Therefore, a user of the vehicle needs to change the connector to be used, depending on the purpose. Therefore, a user who performs both power supply and charging may own both the power supply connector and the charging connector. In this case, it is considered that a space for disposing the power supply connector and the charging connector increases.

The present disclosure has been made to solve the problem described above, and an object of the present disclosure is to provide a connector device capable of suppressing an increase in a disposition space.

A connector device according to an aspect of the present disclosure includes: a connector member that includes a first side portion provided with an inlet connection portion configured to be connectable to an inlet of a vehicle and a locking portion configured to lock the inlet connection portion connected to the inlet, and a second side portion provided at a position different from the first side portion;
a first connection member configured to be detachable from and attachable to the second side portion and to be electrically connectable to an external power supply; and
a second connection member configured to be detachable from and attachable to the second side portion and to be electrically connectable to an external device, in which:
the first connection member is configured to transmit power from the external power supply to the connector member in a state where the first connection member is electrically connected to the external power supply and is connected to the second side portion; and
the second connection member is configured to transmit power from the connector member to the external device in a state where the second connection member is electrically connected to the external device and is connected to the second side portion.

The connector device according to an aspect of the present disclosure includes, as described above, a connector member, a first connection member configured to be detachable from and attachable to the connector member and to be electrically connectable to an external power supply, and a second connection member configured to be detachable from and attachable to the connector member and to be electrically connectable to an external device. As a result, the configuration of the connector device can be simplified by one connector member as compared to a case where both the charging connector in which the connector member and the first connection member are integrated and the discharging connector in which the connector member and the second connection member are integrated are provided. As a result, it is possible to suppress an increase in the disposition space of the connector device.

In addition, since the connector device, the first connection member, and the second connection member are separate components from each other, when any of the connector device, the first connection member, and the second connection member fails, it is possible to independently perform repair or replacement of the failed component. As a result, it is possible to facilitate maintenance of the connector device.

The first connection member may include
a first connector connection portion configured to be connectable to the second side portion, and
a first plug provided at a position different from the first connector connection portion, the first plug being configured to be connectable to a first outlet of the external power supply; and
the second connection member may include
a second connector connection portion configured to be connectable to the second side portion, and
a second outlet provided at a position different from the second connector connection portion, the second outlet being configured to allow a second plug of the external device to be connected to the second outlet.
   With such a configuration, the first connection member can be easily electrically connected to each of the connector member and the external power supply. In addition, the second connection member can be easily electrically connected to each of the connector member and the external device.

The connector member may include a first resistor element unit configured to be electrically connected to the vehicle in a state where the inlet connection portion is connected to the inlet;
the first connection member may be configured not to be electrically connected to the first resistor element unit in a state where the first connection member is connected to the second side portion; and
the second connection member may include a second resistor element unit configured to be electrically connected to the first resistor element unit in a state where the second connection member is connected to the second side portion.
   With such a configuration, it is possible to cause the vehicle to detect whether the first connection member or the second connection member is connected to the connector member (that is, whether charging or discharging is performed) based on the change in the resistance value.

The first resistor element unit may include
a first resistor element, and
a parallel circuit in which a second resistor element and a first switch are connected in parallel, the parallel circuit being configured to be connected in series with the first resistor element;
the connector member may include a first operation unit that is operable;
when the first operation unit is operated, a lock of the locking portion may be released and the first switch may be turned to an open state;
the second resistor element unit may include
a series circuit in which a second switch and a third resistor element are connected in series, and
a fourth resistor element connected to the series circuit in parallel;
the second connection member may include a second operation unit that is operable; and
when the second operation unit is operated, the second switch may be turned to a closed state. With such a configuration, since the resistance value of the connector device changes when the second switch is turned to a closed state in response to an operation of the second operation unit, the vehicle can change a discharging sequence (for example, start a discharging sequence) based on the change in the resistance value. In addition, since the resistance value of the connector device changes when the first switch is turned to an open state in response to an operation of the first operation unit, the vehicle can change a charging sequence (for example, stop a charging sequence) based on the change in the resistance value. In addition, when the first switch is turned to an open state and the lock of the locking portion is released, the connector member can be removed from the inlet in a state where the first switch remains in the open state.

In addition, since the first operation unit and the second operation unit can be respectively disposed on different members, it can be suppressed that the user erroneously operates the first operation unit and the second operation unit (for example, erroneously operates the second operation unit when releasing the locking portion) as compared to a case where the first operation unit and the second operation unit are provided on the same member.

The connector member may include a pilot wiring through which a pilot signal is transmitted;
the second connection member may be configured not to be electrically connected to the pilot wiring in a state where the second connection member is connected to the connector member; and
the first connection member may include a signal generation unit configured to be electrically connected to the pilot wiring in a state where the first connection member is connected to the connector member, and to generate the pilot signal.
   With such a configuration, it is possible to cause the vehicle to detect whether the first connection member or the second connection member is connected to the connector member (that is, whether charging or discharging is performed) based on whether the pilot signal is transmitted from the connector device.

According to the present disclosure, it is possible to suppress an increase in the disposition space of the connector device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a connector device and a vehicle according to the present embodiment;

FIG. 2 is a partially enlarged view of a connection portion between a connector of the connector device and an inlet;

FIG. 3 is a diagram showing a circuit configuration in a state where a connector, to which an AC charging cable is connected, is connected to the inlet; and

FIG. 4 is a diagram showing a circuit configuration in a state where a connector, to which an AC discharge connector is connected, is connected to the inlet.

### DETAILED DESCRIPTION OF EMBODIMENTS

Hereinafter, an embodiment of the present disclosure will be described in detail with reference to the drawings. In the drawings, the same or corresponding parts are denoted by the same reference numerals, and the description thereof will not be repeated.

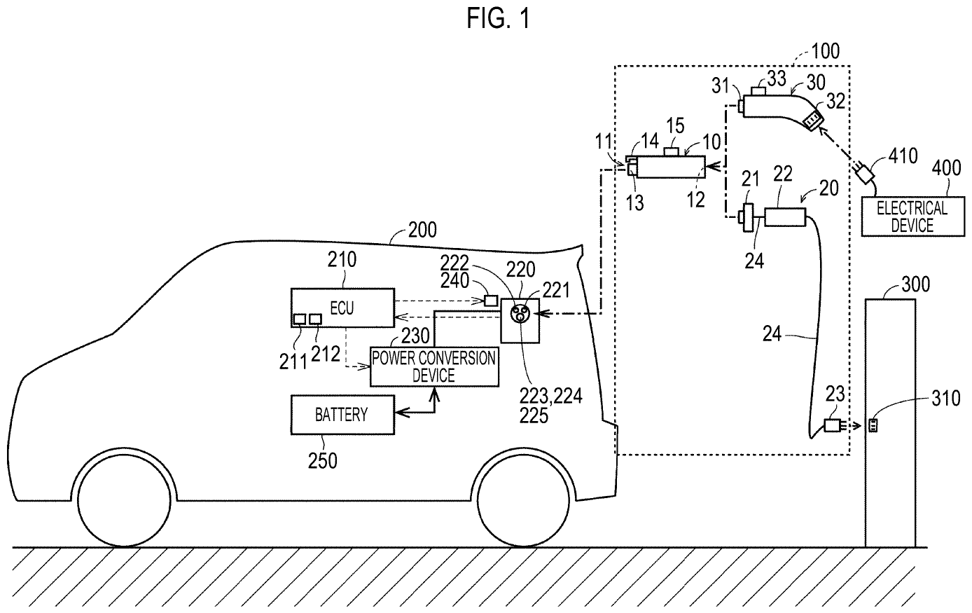

Hereinafter, a configuration of a connector device 100 according to the present embodiment will be described. In FIG. 1, a connector device 100 and a vehicle 200 connected to the connector device 100 are shown. The vehicle 200 is, for example, a plug-in hybrid electric vehicle and a battery electric vehicle.

As shown in FIG. 1, the connector device 100 includes a connector 10, an AC charging cable 20, and an AC discharge connector 30. The connector 10 is an example of a “connector member” of the present disclosure. In addition, the AC charging cable 20 and the AC discharge connector 30 are examples of a “first connection member” and a “second connection member” of the present disclosure, respectively.

The vehicle 200 includes an electronic control unit (ECU) 210, an inlet 220, a power conversion device 230, a locking mechanism 240, and a battery 250.

The connector 10 is configured to be connected to the inlet 220 of the vehicle 200. The connector 10 includes a first end 11, a second end 12, a fitting portion 13, a locking portion 14, and a switch 15. The second end 12 is provided on the opposite side of the first end 11. Each of the fitting portion 13 and the locking portion 14 is provided on the first end 11. The first end 11 and the second end 12 are examples of the “first side portion” and the “second side portion” of the present disclosure, respectively. In addition, the fitting portion 13 and the switch 15 are examples of the “inlet connection portion” and the “first operation unit” of the present disclosure, respectively.

The fitting portion 13 is configured to be connected (fitted) to the inlet 220. The locking portion 14 locks the fitting portion 13 fitted to the inlet 220.

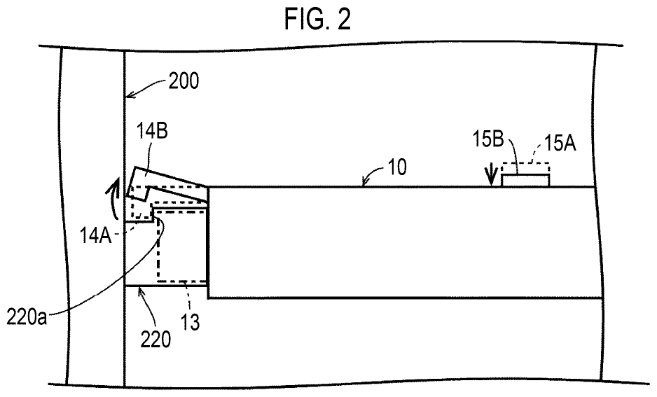

FIG. 2 is a partially enlarged view of the vicinity of the inlet 220 and the fitting portion 13. When the switch 15 (15A, 15B in FIG. 2) is not operated (pressed) by the user, the fitting portion 13 fitted to the inlet 220 is locked by the locking portion 14 (14A, 14B in FIG. 2). Specifically, a step portion 220a provided on the inlet 220 and the tip end of the locking portion 14 engage with each other, thereby restricting the fitting portion 13 from being removed from the inlet 220. In FIG. 2, the switch 15 in the non-operating state and the locking portion 14 in a case where the switch 15 is in the non-operating state are denoted by reference numerals 15A and 14A, and are referred to as switch 15A and locking portion 14A, respectively.

When the switch 15 is operated (pressed), the tip end of the locking portion 14 is lifted, thereby releasing the engagement between the locking portion 14 and the step portion 220a. As a result, the fitting portion 13 can be removed from the inlet 220. In FIG. 2, the switch 15 in the operating state and the locking portion 14 in a case where the switch 15 is in the operating state are denoted by reference numerals 15B and 14B, and are referred to as switch 15B and locking portion 14B, respectively.

Referring to FIG. 1 again, the AC charging cable 20 is configured to be detachably attached to the connector 10. Specifically, the AC charging cable 20 includes a connector 21, a charge circuit interrupt device (CCID) 22, a plug 23, and a cable 24. The connector 21 is disposed at the first end of the AC charging cable 20. The plug 23 is disposed at the second end of the AC charging cable 20 that is on the opposite side from the connector 21. The CCID 22 is disposed between the connector 21 and the plug 23. The cable 24 connects the connector 21, the CCID 22, and the plug 23. The connector 21 is configured to be detachably attached to the second end 12 of the connector 10. The connector 21 and the plug 23 are examples of a “first connector connection portion” and a “first plug” of the present disclosure, respectively.

The AC charging cable 20 is configured to be electrically connected to the external power supply 300. Specifically, the plug 23 of the AC charging cable 20 is configured to be connected to the outlet 310 of the external power supply 300. By connecting the plug 23 to the outlet 310, the external power supply 300 and the AC charging cable 20 are electrically connected. The external power supply 300 may be a charging stand to which power is supplied from a power system (not shown). In addition, the outlet 310 is an example of a “first outlet” of the present disclosure.

The AC discharge connector 30 is configured to be detachably attached to the connector 10. Specifically, the AC discharge connector 30 includes a connector 31, an outlet 32, and a switch 33. The connector 31 is disposed at the first end of the AC discharge connector 30. The outlet 32 is disposed at the second end of the AC discharge connector 30 that is on the opposite side from the connector 31. The connector 31 is configured to be detachably attached to the second end 12 of the connector 10. The connector 31 and the outlet 32 are examples of a “second connector connection portion” and a “second outlet” of the present disclosure, respectively. The switch 33 is an example of a “second operation unit” of the present disclosure.

The AC discharge connector 30 is configured to be electrically connected to the electrical device 400. Specifically, a plug 410 provided on the electrical device 400 is configured to be connected to the outlet 32 of the AC discharge connector 30. By connecting the plug 410 to the outlet 32, the AC discharge connector 30 and the electrical device 400 are electrically connected. The electrical device 400 includes, for example, home appliances that operate on AC 100 V. The electrical device 400 may be other than the home appliances (for example, a power storage device and a power stand). The electrical device 400 and the plug 410 are examples of the “external device” and the “second plug” of the present disclosure, respectively.

The AC charging cable 20 is not provided with a locking portion for locking the connection between the connector 10 and the connector 21. The connector 21 is stably fixed to the connector 10 by being fitted to the second end 12 of the connector 10. Similarly, the AC discharge connector 30 is not provided with a locking portion for locking the connection between the connector 10 and the connector 31. The connector 31 is stably fixed to the connector 10 by being fitted to the second end 12 of the connector 10.

Here, in the connector devices in the related art, since the power supply connector and the charging connector have different configurations, the user of the vehicle needs to change the connector to be used according to the purpose. Therefore, a user who performs both power supply and charging may own both the power supply connector and the charging connector. In this case, it is considered that a space for disposing the power supply connector and the charging connector increases.

Therefore, in the present embodiment, the AC charging cable 20 transmits power from the external power supply 300 to the connector 10 in a state where the AC charging cable 20 is electrically connected to the external power supply 300 and is connected to the connector 10. The AC discharge connector 30 transmits power from the connector 10 (battery 250) to the electrical device 400 in a state where the AC discharge connector 30 is electrically connected to the electrical device 400 and is connected to the connector 10.

As a result, the connector 10 can be used as a common member in both charging and discharging cases. As a result, it is possible to suppress redundancy of the configuration of the connector device 100 as compared with a case where a plurality of members corresponding to the connector 10 is provided. As a result, it is possible to suppress an increase in the disposition space of the connector device 100.

The battery 250 is, for example, a power storage element configured to be recharged, and typically, a secondary battery, such as a nickel-metal hydride battery or a lithium ion battery having a solid or liquid electrolyte, is applied. Alternatively, the battery 250 may be a power storage device that can store power, and for example, a large-capacity capacitor may be used instead of the battery 250.

External charging of the battery 250 is performed using the power supplied from the external power supply 300. The external charging includes the AC charging using the direct current power converted by the power conversion device 230 and supplied from the alternating current power supplied from the external power supply 300 to the inlet 220.

The inlet 220 is provided on an exterior portion of the vehicle 200 together with a cover such as a lid (not shown). The inlet 220 can receive the supply of the power to be used for charging the battery 250 from the external power supply 300. Further, the inlet 220 enables the supply of power from the battery 250 to the electrical device 400 (AC discharge). The AC discharge refers to external discharge that supplies alternating current power from the vehicle 200 to the electrical device 400.

The inlet 220 includes the AC connection portions 221, 222, and the communication portions 223, 224, 225.

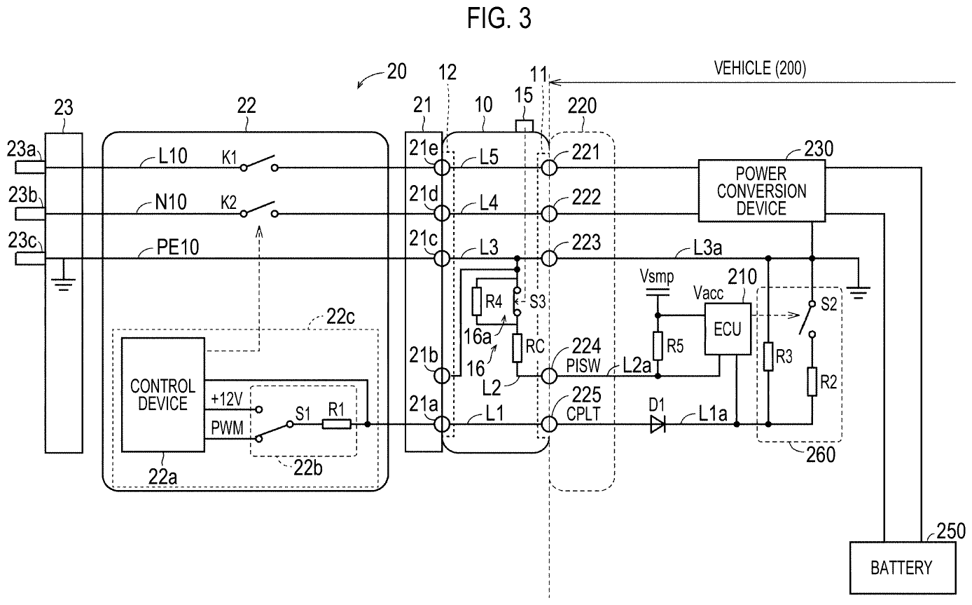

When the connector 10 is connected to the inlet 220, the AC connection portion of the connector 10 (see FIG. 3) is electrically connected to the AC connection portions 221, 222 of the inlet 220, and the communication portion of the connector 10 (see FIG. 3) is connected to the communication portions 223 to 225 of the inlet 220.

The power conversion device 230 performs power conversion between the battery 250 and the inlet 220 in response to a control signal from the ECU 210.

The power conversion device 230 converts the alternating current power supplied from the AC charging cable 20 into direct current power and charges the battery 250 using the converted direct current power when AC charging is performed on the battery 250 in a state where the connector 10 connected to the AC charging cable 20 is connected to the inlet 220.

Further, when the AC discharge is performed using the battery 250 in a state where the connector 10 connected to the AC discharge connector 30 is connected to the inlet 220 and the plug 410 of the electrical device 400 is connected to the outlet 32 of the AC discharge connector 30, the power conversion device 230 converts the direct current power supplied from the battery 250 into the alternating current power and supplies the converted alternating current power (for example, AC 100 V) to the electrical device 400.

The locking mechanism 240 restricts the removal of the connector 10 attached to the inlet 220, thereby fixing the connector 10 to the inlet 220 (locked state), or releases the restriction on the removal of the connector 10, thereby enabling the connector 10 to be removed from the inlet 220 (unlocked state). The locking mechanism 240 is provided with, for example, an actuator that moves a member to a position that restricts the movement of the connector 10 in a state of being attached to the inlet 220 to establish a locked state, or moves the member to a position that enables the movement of the connector 10 in a state of being attached to the inlet 220 to establish an unlocked state. That is, the locking mechanism 240 switches from one state of the locked state and the unlocked state to the other state in response to the control signal from the ECU 210.

The ECU 210 includes a central processing unit (CPU) 211 and a memory (such as a read only memory (ROM), a random access memory (RAM)) 212, and controls the devices (for example, the power conversion device 230, the locking mechanism 240, or the power conversion device 230) such that the vehicle 200 achieves a desired state based on information such as a map and a program stored in the memory 212 and information from various sensors. The various controls performed by the ECU 210 are not limited to being processed by software, but may be processed by constructing dedicated hardware (electronic circuits).

Further, when the connector 10 (the connector 10 connected to the AC charging cable 20 or the AC discharge connector 30) is attached to the inlet 220, the ECU 210 executes communication processing to receive predetermined information from the equipment on the connector side. The predetermined information includes, for example, information regarding the power that can be exchanged between the external power supply 300 and the battery 250 (such as a connector connection signal PISW to be described later).

The ECU 210, for example, when the connector 10 is attached to the inlet 220, connects the communication portion of the connector 10 (see FIG. 3) and the communication portions 223, 224, 225 of the inlet 220, and receives the information on the power being exchanged between the attached connector 10 and the inlet 220. The information indicates that the power being exchanged is alternating current power, charging power, discharging power, or the like.

FIG. 3 shows an example of a circuit configuration in a state where the connector 10 connected to the AC charging cable 20 is connected to the inlet 220. The following description with reference to FIG. 3 is a description of a configuration in a state where the connector 10 connected to the AC charging cable 20 is connected to the inlet 220.

The AC charging cable 20 includes a voltage line L10, a voltage line N10, and a ground line PE10. The voltage line L10, the voltage line N10, and the ground line PE10 are connected to the terminal 23a, the terminal 23b, and the terminal 23c of the plug 23, respectively. The terminal 23c (ground line PE10) is grounded.

The CCID 22 includes the relays K1, K2, the control device 22a, and the oscillation circuit 22b. The relay K1 and the relay K2 are disposed on the voltage line L10 and the voltage line N10, respectively. A signal generation unit 22c is configured by the control device 22a and the oscillation circuit 22b. The signal generation unit 22c (oscillation circuit 22b) is electrically connected to a signal line L1 (described later) of the connector 10 in a state where the connector 21 is connected to the connector 10 (the second end 12). When the relays K1, K2 are in the open state, the power supply path is cut off. When the relays K1, K2 are in the closed state, the alternating current power from the external power supply 300 (FIG. 1) can be supplied to the vehicle 200 via the AC charging cable 20, the connector 10, and the inlet 220.

The oscillation circuit 22b outputs the pilot signal CPLT to the ECU 210 via the connector 10 and the inlet 220. The potential of the pilot signal CPLT is operated by the ECU 210 and is used as a signal for remotely operating the relays K1, K2 from the ECU 210.

The control device 22a controls the relays K1, K2 based on the potential of the pilot signal CPLT. The pilot signal CPLT is used as a signal for notifying the ECU 210 of the rated current during the AC charging from the oscillation circuit 22b to the ECU 210.

The control device 22a includes a CPU, memory, and the like (none of which are shown in the drawings). The control device 22a detects the potential of the pilot signal CPLT output by the oscillation circuit 22b, and controls the operation of the oscillation circuit 22b based on the detected potential of the pilot signal CPLT.

When the connector 10 is not connected to the inlet 220, the control device 22a controls the operation of the oscillation circuit 22b such that the non-oscillating pilot signal CPLT having a potential of V0 (for example, +12V) is output.

Specifically, the oscillation circuit 22b includes, for example, a switch S1 and a resistor R1. A first end of the resistor R1 is connected to the switch S1. The switch S1 is disposed between the resistor R1 and the control device 22a.

The switch S1 is configured to conduct either the +12V power supply of the control device 22a or the oscillation device of the control device 22a, along with the resistor R1. When the connector 10 is not connected to the inlet 220, the control device 22a controls the switch S1 such that the +12V power supply and the resistor R1 are in a conductive state. Therefore, the oscillation circuit 22b outputs the non-oscillation pilot signal CPLT having a potential of +12V to the terminal 21a (described later).

When the connector 10 is connected to the inlet 220, the control device 22a controls the operation of the oscillation circuit 22b such that the pilot signal CPLT that oscillates at a predetermined frequency and duty cycle is output.

Specifically, for example, when the connector 10 is connected to the inlet 220, the resistor R1 and the resistor R3 on the vehicle 200 side (described later) are in a conductive state, and the potential of the pilot signal CPLT drops to V1 lower than V0. Therefore, the control device 22a controls the switch S1 such that the oscillation device and the resistor R1 are in a conductive state. Therefore, the oscillation circuit 22b outputs the pilot signal CPLT that has an upper limit value of the potential of V1 and oscillates at the specified frequency and duty cycle to the terminal 21a (described later).

When the upper limit value of the potential of the pilot signal CPLT drops to V2 (<V1), the control device 22a controls the relays K1, K2 to be in the closed state. As a result, the power from the external power supply 300 is supplied to the inlet 220 via the AC charging cable 20 and the connector 10. The upper limit value of the potential of the pilot signal CPLT, for example, drops to V2 when the switch S2 (described later) is in a conductive state.

The connector 10 includes signal lines L1 to L5. Each of the signal lines L1 to L5 is electrically connected to the vehicle 200 in a state where the fitting portion 13 (FIG. 1) is fitted to the inlet 220. The signal line L1 is an example of the “pilot wiring” of the present disclosure.

The connector 10 includes a resistor element unit 16. The resistor element unit 16 includes a resistor R4, a resistor RC, and a switch S3. The resistor element unit 16 is an example of a “first resistor element unit” of the present disclosure. The resistor RC is an example of a “first resistor element” of the present disclosure. In addition, the resistor R4 and the switch S3 are examples of a “second resistor element” and a “first switch” of the present disclosure, respectively.

The resistor R4 and the switch S3 are connected in parallel to each other, and constitute a parallel circuit 16a. The resistor RC is connected in series with the parallel circuit 16a. The resistor RC is disposed between the parallel circuit 16a and the communication portion 224 in a state where the connector 10 is connected to the inlet 220.

A resistance value of the resistor RC is smaller than a resistance value of the resistor R4. For example, the resistance value of the resistor RC may be less than or equal to ½ of the resistance value of the resistor R4.

The switch S3 is a switch corresponding to the switch 15. Specifically, when the switch 15 is operated (pressed), the switch S3 turns to an open state, and when the switch 15 is not operated (pressed), the switch S3 turns to a closed state.

The combined resistance value of the resistor element unit 16 when the switch S3 is in the open state is different from the combined resistance value of the resistor element unit 16 when the switch S3 is in the closed state.

The connector 21 includes terminals 21a to 21e. The signal line L1 electrically connects the communication portion 225 of the inlet 220 and the terminal 21a of the connector 21. The terminal 21a is electrically connected to the control device 22a and the oscillation circuit 22b.

The signal line L2 electrically connects the communication portion 224 of the inlet 220 and the terminal 21b of the connector 21. The resistor element unit 16 is disposed on the signal line L2. The AC charging cable 20 does not include a wiring electrically connected to the signal line L2 in a state where the AC charging cable 20 is connected to the second end 12 of the connector 10. Each of the switch S3 and the resistor R4 is connected to the ground line L3.

The ground line L3 electrically connects the communication portion 223 of the inlet 220 and the terminal 21c of the connector 21. The ground line PE10 is connected to the terminal 21c.

The signal line L4 electrically connects the AC connection portion 222 of the inlet 220 and the terminal 21d of the connector 21. The voltage line N10 is connected to the terminal 21d.

The signal line L5 electrically connects the AC connection portion 221 of the inlet 220 and the terminal 21e of the connector 21. The voltage line L10 is connected to the terminal 21e.

The vehicle 200 further includes a resistor circuit 260 including a switch S2, a resistor R2, and a resistor R3. The vehicle 200 includes a signal line L1a connected to the communication portion 225, a signal line L2a connected to the communication portion 224, and a ground line L3a connected to the communication portion 223. The ground line L3a is grounded. The resistor circuit 260 is a circuit for operating the potential of the pilot signal CPLT generated on the signal line L1. A diode D1 is disposed on the signal line L1a, with a forward direction being from the communication portion 225 side toward the resistor R2 (R3) side.

A first end of the resistor R2 is connected to the ground line L3a via a switch S2. The second end of the resistor R2 is connected to a signal line L1a to which the pilot signal CPLT is generated. The resistor R3 is connected between the signal line L1a and the ground line L3a. That is, the first end of the resistor R3 is connected to the ground line L3a. The second end of the resistor R3 is connected to the signal line L1a. The switch S2 is turned on/off in response to a control signal from the ECU 210.

In a state where the connector 10 is connected to the inlet 220, when the switch S2 is in an off state (cut-off state), the potential of the pilot signal CPLT becomes a potential (V1) determined by the resistor R1 and the resistor R3. In a state where the connector 10 is connected to the inlet 220, when the switch S2 is in an on state (conductive state), the potential of the pilot signal CPLT becomes a potential (V2) determined by the resistor R1, the resistor R2, and the resistor R3.

When the connector 10 is connected to the inlet 220, the ECU 210 switches the on/off of the switch S2 to change the potential of the pilot signal CPLT, thereby requesting power supply and stop of the power supply to the AC charging cable 20.

Specifically, the ECU 210 requests the power supply to the AC charging cable 20, for example, by turning the switch S2 to an on state to change the potential of the pilot signal CPLT from V1 to V2. The ECU 210 requests the stop of power supply to the AC charging cable 20, for example, by turning the switch S2 to an off state to change the potential of the pilot signal CPLT from V2 to V1.

When the switch S2 is turned to an on state, causing the control device 22a to turn the relays K1, K2 to a closed state, the alternating current power is supplied from the AC charging cable 20 to the power conversion device 230 via the inlet 220. The ECU 210 operates the power conversion device 230 to convert the alternating current power into the direct current power to charge the battery 250 after the completion of the predetermined charge preparation process.

The vehicle 200 includes a resistor R5 and a power supply Vsmp. A first end of the resistor R5 is connected to the communication portion 224, and a second end of the resistor R5 is connected to the power supply Vsmp. The ECU 210 is configured to be capable of acquiring the potential between the resistor R5 and the communication portion 224. The resistor RC, the resistor R4, the resistor R5, the switch S3, and the power supply Vsmp configure a connection detection circuit that detects a connection state between the connector 10 and the inlet 220.

When the connector 10 is not connected to the inlet 220, the signal of the potential (V3) determined by the voltage of the power supply Vsmp and the resistance value of the resistor R5 is generated on the signal line L2a as the connector connection signal PISW.

When the connector 10 is connected to the inlet 220 and the switch 15 is in the non-operating state, a signal of a potential (V4) determined by the voltage of the power supply Vsmp, the resistor R5, and the resistor RC is generated on the signal line L2a as the connector connection signal PISW.

When the switch 15 is operated in a state where the connector 10 is connected to the inlet 220, a signal of a potential (V5) determined by the voltage of the power supply Vsmp, the resistor R4, the resistor R5, and the resistor RC is generated on the signal line L2a as the connector connection signal PISW.

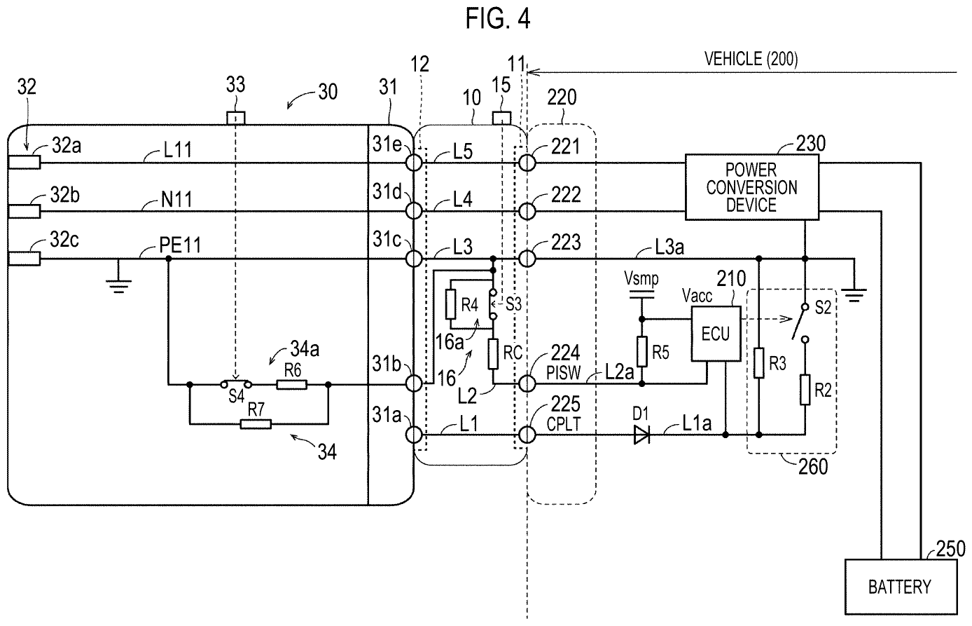

FIG. 4 shows an example of a circuit configuration in a state where the connector 10 connected to the AC discharge connector 30 is connected to the inlet 220. The following description with reference to FIG. 4 is a description of a configuration in a state where the connector 10 connected to the AC discharge connector 30 is connected to the inlet 220.

The AC discharge connector 30 includes a voltage line L11, a voltage line N11, and a ground line PE11. The voltage line L11, the voltage line N11, and the ground line PE11 are connected to the terminal 32a, the terminal 32b, and the terminal 32c of the outlet 32, respectively. The terminal 32c (ground line PE11) is grounded.

The AC discharge connector 30 includes a resistor element unit 34. The resistor element unit 34 includes a resistor R6, a resistor R7, and a switch S4. Each of the switch S4 and the resistor R7 is connected to the ground line PE11. The resistor element unit 34 and the resistor R6 are examples of a “second resistor element unit” and a “third resistor element” of the present disclosure, respectively. In addition, the resistor R7 and the switch S4 are examples of a “fourth resistor element” and a “second switch” of the present disclosure, respectively.

The resistor R6 and the switch S4 are connected in series. The series circuit 34a is configured by the resistor R6 and the switch S4. The resistor R7 is connected in parallel with the series circuit 34a. The resistor R6 is connected to a terminal 31b described later.

A resistance value of the resistor R6 is smaller than a resistance value of the resistor R7. For example, the resistance value of the resistor R6 may be less than or equal to ½ of the resistance value of the resistor R7. The resistor R6 may be less than or equal to the resistor RC of the connector 10. The resistor R7 may be larger than the resistor RC and may be less than or equal to the resistor R4.

The switch S4 is a switch corresponding to the switch 33. Specifically, when the switch 33 is operated (pressed), the switch S3 turns to a closed state. When the switch S3 is in the closed state and the switch 33 is operated a plurality of times consecutively, the switch S4 may be changed to the open state.

The combined resistance value of the resistor element unit 34 when the switch S4 is in the open state is different from the combined resistance value of the resistor element unit 34 when the switch S4 is in the closed state.

The connector 31 includes terminals 31a to 31e. The signal line L1 electrically connects the communication portion 225 of the inlet 220 and the terminal 31a of the connector 31. The wiring in the AC discharge connector 30 is not connected to the terminal 31a. That is, the AC discharge connector 30 is not electrically connected to the signal line L1 in a state where the AC discharge connector 30 is connected to the connector 10.

The signal line L2 electrically connects the communication portion 224 of the inlet 220 and the terminal 31b of the connector 31. The terminal 31b is connected to the resistor element unit 34. That is, the resistor element unit 34 is electrically connected to the resistor element unit 16 in a state where the AC discharge connector 30 is connected to the connector 10 (the second end 12). As a result, the resistor element unit 16 and the resistor element unit 34 are connected in series.

The ground line L3 electrically connects the communication portion 223 of the inlet 220 and the terminal 31c of the connector 31. The ground line PE11 is connected to the terminal 31c.

The signal line L4 electrically connects the AC connection portion 222 of the inlet 220 and the terminal 31d of the connector 31. The voltage line N11 is connected to the terminal 31d.

The signal line L5 electrically connects the AC connection portion 221 of the inlet 220 and the terminal 31e of the connector 31. The voltage line L11 is connected to the terminal 31e.

When the switch 15 is in the non-operating state and the switch 33 is in the non-operating state, the switch S3 turns to the closed state and the switch S4 turns to the open state. In this case, a signal of a potential (V6) determined by the voltage of the power supply Vsmp, the resistor R5, the resistor RC, and the resistor R7 is generated on the signal line L2a as a connector connection signal PISW.

When the switch 15 is operated and the switch 33 is in the non-operating state, the switch S3 turns to the open state and the switch S4 turns to the open state. In this case, a signal of a potential (V7) determined by the voltage of the power supply Vsmp, the resistor R5, the resistor RC, the resistor R4, and the resistor R7 is generated on the signal line L2a as a connector connection signal PISW.

When the switch 15 is in the non-operating state and the switch 33 is operated, the switch S3 turns to the closed state and the switch S4 turns to the closed state. In this case, a signal of a potential (V8) determined by the voltage of the power supply Vsmp, the resistor R5, the resistor RC, the resistor R6, and the resistor R7 is generated on the signal line L2a as a connector connection signal PISW.

When the switch 15 is operated and the switch 33 is operated, the switch S3 turns to the open state and the switch S4 turns to the closed state. In this case, a signal of a potential (V9) determined by the voltage of the power supply Vsmp, the resistor R5, the resistor R4, the resistor RC, the resistor R6, and the resistor R7 is generated on the signal line L2a as a connector connection signal PISW.

The ECU 210 can determine whether the connector device 100 is connected to the inlet 220 and the state of the connector device 100 connected to the inlet 220 by acquiring the potential of the connector connection signal PISW. Specifically, the ECU 210 calculates a resistance value (resistance value of the circuit connected to the power supply Vsmp) based on the potential of the connector connection signal PISW, and performs the determination based on the calculated resistance value. The ECU 210 calculates the resistance value of the circuit excluding the resistor R5 in the circuit.

The resistance values of the resistors (R4, R5, R6, R7, RC) are set such that the potentials V3 to V9 are different from each other (voltage range). The memory 212 of the ECU 210 stores information on the resistance value corresponding to each of the potentials V3 to V9. The ECU 210 performs the determination by comparing the resistance value calculated based on the potential of the connector connection signal PISW with the resistance value stored in the memory 212. The resistance values corresponding to the potentials V4 and V5 may be values determined by a standard called SAE-J1772. The resistance values corresponding to the potentials V6 to V9 may be values determined by a guideline called EVPS-003. The resistance value corresponding to the potential V3 is 0.

For example, when the calculated resistance value is the resistance value corresponding to the potential V4, the ECU 210 may request the power supply to the AC charging cable 20 by turning the switch S2 to an on state (conductive state).

When the calculated resistance value is the resistance value corresponding to the potential V8, the ECU 210 may start the discharge sequence of the battery 250.

### Modification

In the embodiment, an example has been described in which the AC charging cable 20 and the AC discharge connector 30 are configured to be connected to the connector 10, but the present disclosure is not limited thereto. For example, instead of the AC charging cable 20, a member for DC charging (connector, cable, or the like) may be configured to be connected to the connector 10. In addition, the AC charging cable 20, the AC discharge connector 30, and the member for DC charging may be configured to be connected to the connector 10.

The embodiments disclosed this time should be considered illustrative and not restrictive in all respects. The scope of the present disclosure is indicated by the scope of claims rather than by the above description, and is intended to include all modifications within the scope and meaning equivalent to the scope of the claims.

What is claimed is:

1. A connector device comprising:
a connector member that includes a first side portion provided with an inlet connection portion configured to be connectable to an inlet of a vehicle and a locking portion configured to lock the inlet connection portion connected to the inlet, and a second side portion provided at a position different from the first side portion;
a first connection member configured to be detachable from and attachable to the second side portion and to be electrically connectable to an external power supply; and
a second connection member configured to be detachable from and attachable to the second side portion and to be electrically connectable to an external device, wherein:
the first connection member is configured to transmit power from the external power supply to the connector member in a state where the first connection member is electrically connected to the external power supply and is connected to the second side portion; and
the second connection member is configured to transmit power from the connector member to the external device in a state where the second connection member is electrically connected to the external device and is connected to the second side portion.

2. The connector device according to claim 1, wherein:
the first connection member includes
a first connector connection portion configured to be connectable to the second side portion, and
a first plug provided at a position different from the first connector connection portion, the first plug being configured to be connectable to a first outlet of the external power supply; and
the second connection member includes
a second connector connection portion configured to be connectable to the second side portion, and
a second outlet provided at a position different from the second connector connection portion, the second outlet being configured to allow a second plug of the external device to be connected to the second outlet.

3. The connector device according to claim 1, wherein:
the connector member includes a first resistor element unit configured to be electrically connected to the vehicle in a state where the inlet connection portion is connected to the inlet;
the first connection member is configured not to be electrically connected to the first resistor element unit in a state where the first connection member is connected to the second side portion; and
the second connection member includes a second resistor element unit configured to be electrically connected to the first resistor element unit in a state where the second connection member is connected to the second side portion.

4. The connector device according to claim 3, wherein:
the first resistor element unit includes
a first resistor element, and
a parallel circuit in which a second resistor element and a first switch are connected in parallel, the parallel circuit being configured to be connected in series with the first resistor element;
the connector member includes a first operation unit that is operable;
when the first operation unit is operated, a lock of the locking portion is released and the first switch is turned to an open state;
the second resistor element unit includes
a series circuit in which a second switch and a third resistor element are connected in series, and
a fourth resistor element connected to the series circuit in parallel;
the second connection member includes a second operation unit that is operable; and
when the second operation unit is operated, the second switch is turned to a closed state.

5. The connector device according to claim 1, wherein:
the connector member includes a pilot wiring through which a pilot signal is transmitted;
the second connection member is configured not to be electrically connected to the pilot wiring in a state where the second connection member is connected to the connector member; and
the first connection member includes a signal generation unit configured to be electrically connected to the pilot wiring in a state where the first connection member is connected to the connector member, and to generate the pilot signal.
